(19) United States
(12) Patent Application Publication
(10) Pub. No.: US 2025/0119211 A1
(43) Pub. Date: Apr. 10, 2025

(54) LIGHT MONITORING DEVICE, LIGHT MONITORING SYSTEM, AND LIGHT MONITORING METHOD

(71) Applicant: NEC Corporation, Minato-ku, Tokyo (JP)

(72) Inventor: Taketo ONUMA, Tokyo (GB)

(73) Assignee: NEC Corporation, Minato-ku, Tokyo (JP)

(21) Appl. No.: 18/729,785

(22) PCT Filed: Feb. 28, 2022
(86) PCT No.: PCT/JP2022/008230

§ 371 Date: Jul. 17, 2024

(51) Int. Cl. H04B 10/077; H04B 10/079; H04B 10/25

(52) U.S. Cl. CPC H04B 10/0775; H04B 10/07955; H04B 10/25

(57) ABSTRACT

A light monitoring device according to the present disclosure comprises: a light spectrum generator that generates the light spectrum information of propagating light that propagates via a light path switching device for switching signal light paths; an identified-light information generator that generates, from the light spectrum information, identified-light information related to the spectrum form of identified light included in the propagating light; and a switching state determiner that determines the switching state of the light path switching device from the identified-light information.

### TECHNICAL FIELD

The present invention relates to a light monitoring device, a light monitoring system, and a light monitoring method, and especially relates to a light monitoring device, a light monitoring system, and a light monitoring method to be used in an optical submarine cable system.

### BACKGROUND ART

Optical submarine cable systems connecting continents with optical fibers play an important role as an infrastructure supporting international communication networks. The optical submarine cable system is constituted of a submarine cable accommodating an optical fiber, an optical repeater mounted with an optical amplifier, a branching unit that splits an optical signal, a terminal station device installed in a land station, and the like. One example of such an optical submarine cable system is described in PTL 1.

### CITATION LIST

### Patent Literature

[PTL 1] Japanese Unexamined Patent Application Publication No. 2018-078452

### SUMMARY OF INVENTION

### Technical Problem

In recent years, a configuration that enables switching of an optical transmission path by introducing a branching unit (BU) equipped with an optical switch in the optical transmission path has been generally adopted as an optical submarine cable system. In such an optical submarine cable system, a switching state of a branching unit installed under sea is monitored by using an optical transceiver such as a transponder installed in a land station.

Meanwhile, in the optical submarine cable system, an open cable method in which an open-specified transponder is individually procured has been developed. In the optical submarine cable system based on such an open cable method, only a submarine apparatus such as an optical repeater and a branching unit, and a submarine cable are installed at initial introduction, and an optical transceiver such as a transponder is not necessarily introduced. In this case, at a time when the optical submarine cable system is initially introduced, it is difficult to monitor a switching state of the branching unit during the initial introduction of the optical submarine cable system.

Thus, the optical submarine cable system based on the open cable method has a problem that a switching state of a branching unit cannot be monitored during initial introduction.

An object of the present invention is to provide a light monitoring device, a light monitoring system, and a light monitoring method that solve a problem that a switching state of a branching unit cannot be monitored during initial introduction, in an optical submarine cable system based on an open cable method.

### Solution to Problem

A light monitoring device according to the present invention includes: an light spectrum generating means for generating light spectrum information of propagating light propagating via an optical path switching device that switches a signal light path; an identification light information generating means for generating, from the light spectrum information, identification light information related to a spectral form of identification light included in the propagating light; and a switching state determining means for determining a switching state of the optical path switching device, based on the identification light information.

A light monitoring method according to the present invention includes: generating light spectrum information of propagating light propagating via an optical path switching device that switches a signal light path; generating, from the light spectrum information, identification light information related to a spectral form of identification light included in the propagating light; and determining a switching state of the optical path switching device, based on the identification light information.

### Advantageous Effects of Invention

According to the light monitoring device, the light monitoring system, and the light monitoring method of the present invention, a switching state of a branching unit during initial introduction can be monitored, even in an optical submarine cable system based on an open cable method.

### BRIEF DESCRIPTION OF DRAWINGS

FIG. 1 is a block diagram illustrating a configuration of a light monitoring device according to a first example embodiment of the present invention.

FIG. 2 is a block diagram illustrating one example of a configuration of an optical submarine cable system in which the light monitoring device according to the first example embodiment of the present invention is used.

FIG. 3 is a diagram illustrating one example of a light spectrum of propagating light received by the light monitoring device according to the first example embodiment of the present invention.

FIG. 4 is a block diagram illustrating another example of the configuration of an optical submarine cable system in which the light monitoring device according to the first example embodiment of the present invention is used.

FIG. 5A is a diagram that illustrates a propagating light spectrum received by the light monitoring device according to the first example embodiment of the present invention, and the diagram illustrates a case in which an optical path switching device is in a first switching pattern and the light monitoring device is installed in a terminal station A.

FIG. 5B is a diagram that illustrates the propagating light spectrum received by the light monitoring device according to the first example embodiment of the present invention, and the diagram illustrates a case in which the optical path switching device is in the first switching pattern and the light monitoring device is installed in a terminal station B.

FIG. 5C is a diagram that illustrates the propagating light spectrum received by the light monitoring device according to the first example embodiment of the present invention, and the diagram illustrates a case in which the optical path switching device is in the first switching pattern and the light monitoring device is installed in a terminal station C.

FIG. 5D is a diagram that illustrates the propagating light spectrum received by the light monitoring device according to the first example embodiment of the present invention, and the diagram illustrates a case in which the optical path switching device is in the first switching pattern and the light monitoring device is installed in a terminal station D.

FIG. 6A is a diagram that illustrates the propagating light spectrum received by the light monitoring device according to the first example embodiment of the present invention, and the drawing illustrates a case in which the optical path switching device is in a second switching pattern and the light monitoring device is installed in the terminal station A.

FIG. 6B is a diagram that illustrates the propagating light spectrum received by the light monitoring device according to the first example embodiment of the present invention, and the diagram illustrates a case in which the optical path switching device is in the second switching pattern and the light monitoring device is installed in the terminal station B.

FIG. 6C is a diagram that illustrates the propagating light spectrum received by the light monitoring device according to the first example embodiment of the present invention, and the diagram illustrates optical path switching device is in the second switching pattern and the light monitoring device is installed in the terminal station C.

FIG. 6D is a diagram that illustrates the propagating light spectrum received by the light monitoring device according to the first example embodiment of the present invention, and the diagram illustrates a case in which the optical path switching device is in the second switching pattern and the light monitoring device is installed in the terminal station D.

FIG. 7A is a diagram that illustrates the propagating light spectrum received by the light monitoring device according to the first example embodiment of the present invention, and the diagram illustrates a case in which the optical switching device is in a third switching pattern and the light monitoring device is installed in the terminal station A.

FIG. 7B is a diagram that illustrates the propagating light spectrum received by the light monitoring device according to the first example embodiment of the present invention, and the diagram illustrates a case in which the optical switching device is in the third switching pattern and the light monitoring device is installed in the terminal station B.

FIG. 7C is a diagram that illustrates the propagating light spectrum received by the light monitoring device according to the first example embodiment of the present invention, and the diagram illustrates a case in which the optical switching device is in the third switching pattern and the light monitoring device is installed in the terminal station C.

FIG. 7D is a diagram that illustrates the propagating light spectrum received by the light monitoring device according to the first example embodiment of the present invention, and the diagram illustrates a case in which the optical switching device is in the third switching pattern and the light monitoring device is installed in the terminal station D.

FIG. 8A is a diagram that illustrates the propagating light spectrum received by the light monitoring device according to the first example embodiment of the present invention, and the diagram illustrates a case in which the optical path switching device is in a fourth switching pattern and the light monitoring device is installed in the terminal station A.

FIG. 8B is a diagram that illustrates the propagating light spectrum received by the light monitoring device according to the first example embodiment of the present invention, and the diagram illustrates a case in which the optical path switching device is in the fourth switching pattern and the light monitoring device is installed in the terminal station B.

FIG. 8C is a diagram that illustrates the propagating light spectrum received by the light monitoring device according to the first example embodiment of the present invention, and the diagram illustrates a case in which the optical path switching device is in the fourth switching pattern and the light monitoring device is installed in the terminal station C.

FIG. 8D is a diagram that illustrates the propagating light spectrum received by the light monitoring device according to the first example embodiment of the present invention, and the diagram illustrates a case in which the optical path switching device is in the fourth switching pattern and the light monitoring device is installed in the terminal station D.

FIG. 9 is a block diagram illustrating another configuration of the light monitoring device according to the first example embodiment of the present invention.

FIG. 10A is a diagram schematically illustrating a form of a spectral line of amplified spontaneous emission light acquired by the light monitoring device according to the first example embodiment of the present invention.

FIG. 10B is a diagram schematically illustrating another form of the spectral line of the amplified spontaneous emission light acquired by the light monitoring device according to the first example embodiment of the present invention.

FIG. 10C is a diagram schematically illustrating yet another form of the spectral line of the amplified spontaneous emission light acquired by the light monitoring device according to the first example embodiment of the present invention.

FIG. 11 is a flowchart for describing a light monitoring method according to the first example embodiment according to the present invention.

FIG. 12 is a block diagram illustrating a configuration of a light monitoring system according to a second example embodiment of the present invention.

FIG. 13 is a block diagram illustrating a configuration of an optical device included in the light monitoring system according to the second example embodiment of the present invention.

FIG. 14 is a block diagram illustrating another configuration of the light monitoring system according to the second example embodiment of the present invention.

FIG. 15 is a flowchart for describing a light monitoring method according to the second example embodiment of the present invention.

### EXAMPLE EMBODIMENT

In the following, example embodiments of the present invention are described with reference to the drawings.

### First Example Embodiment

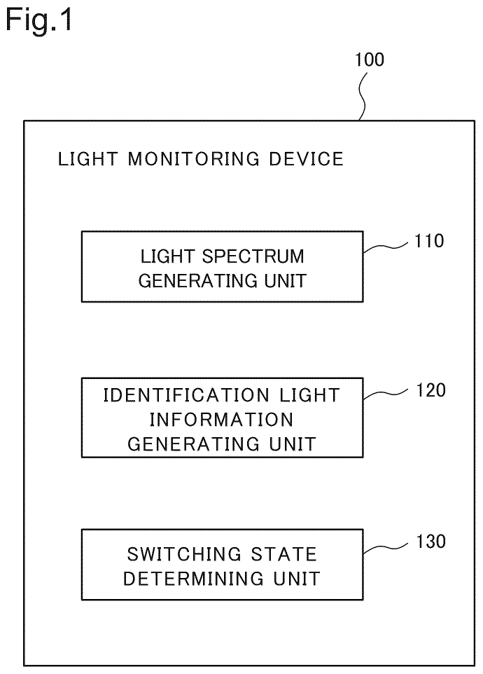

FIG. 1 is a block diagram illustrating a configuration of a light monitoring device 100 according to a first example embodiment of the present invention. The light monitoring device 100 includes a light spectrum generating unit (a light spectrum generating means) 110, an identification light information generating unit (an identification light information generating means) 120, and a switching state determining unit (a switching state determining means) 130. Preferably, the light monitoring device 100 is used in a terminal station constituting an optical submarine cable system.

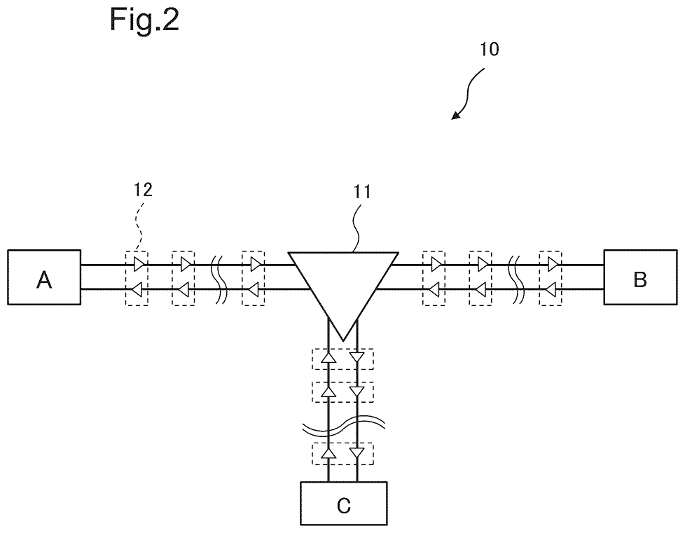

As one example of the optical submarine cable system, a configuration of an optical submarine cable system 10 including terminal stations A, B, C each installed with a terminal station device, an optical path switching device 11 as a branching unit, and an optical repeater 12 is illustrated in FIG. 2. The optical path switching device 11 typically includes an optical switch or an optical add-drop multiplexer (OADM). Further, the optical repeater 12 typically includes an erbium-doped fiber amplifier (EDFA). The optical path switching device 11 and the terminal station device installed in each of the terminal station A, B, C are connected, for example, by a fiber pair. Herein, the fiber pair (FP) is constituted of an uplink optical fiber and a downlink optical fiber.

In the light monitoring device 100 illustrated in FIG. 1, the light spectrum generating unit 110 generates light spectrum information of propagating light propagating via the optical path switching device 11 that switches a signal light path. The identification light information generating unit 120 generates, from the light spectrum information, identification light information related to a spectral form of identification light included in the propagating light. Then, the switching state determining unit 130 determines a switching state of the optical path switching device 11, based on the identification light information.

Thus, the light monitoring device 100 according to the present example embodiment is constituted in such a way as to determine a switching state of the optical path switching device 11, based on the identification light information related to the spectral form of the identification light included in the propagating light. Therefore, there is no need to introduce an optical transceiver such as a transponder in order to determine a switching state of the optical path switching device 11. Specifically, according to the light monitoring device 100 of the present example embodiment, a switching state of the branching unit during initial introduction can be monitored, even in an optical submarine cable system based on an open cable method.

An optical interface device (open cable interface: OCI) included in the terminal station device in the optical submarine cable system based on the open cable method may be used as the light monitoring device 100. In this case, an optical channel monitor (OCM) included in the optical interface device (OCI) may be used as the light spectrum generating unit 110. Alternatively, a light spectrum analyzer may be used as the light spectrum generating unit 110.

The above-described propagating light is amplified spontaneous emission light (ASE light) that is inserted at an optical device at a previous stage of the optical path switching device 11. Herein, the optical device may be installed in any one of the terminal stations A, B, C. Further, the above-described identification light is amplified spontaneous emission light (ASE light) having a different spectral form for each optical device.

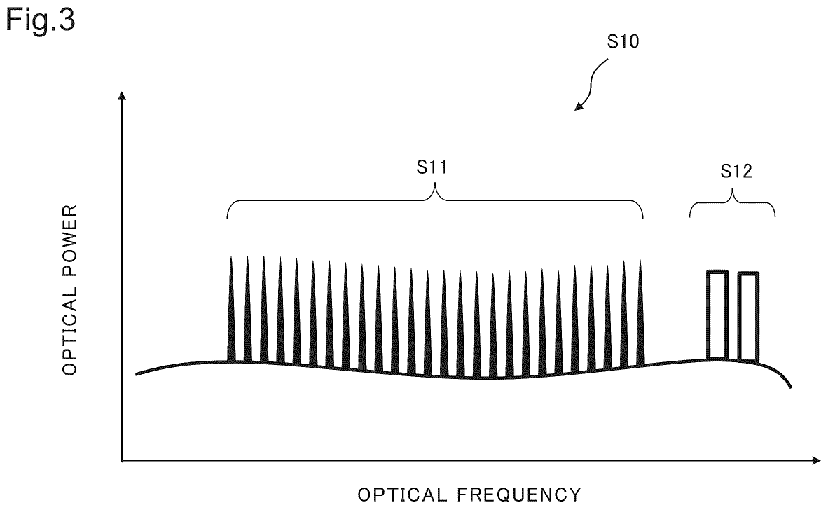

One example of a light spectrum of the propagating light is illustrated in FIG. 3. Propagating light S10 includes, in a main signal band, modulating light S11 for keeping output optical intensity of the optical device constant. The modulating light S21 is dummy light inserted instead of a main optical signal. Further, identification light S12 is included in a non-allocated band excluding the main signal band. By such an arrangement, the identification light S12 can be used continuously, even after an optical transceiver such as a transponder is connected to the optical submarine cable system and main signal light is introduced into the main signal band. Alternatively, the identification light S12 may be included in the main signal band.

The above-described spectral form of the identification light S12 is at least one of the number of spectral lines of the amplified spontaneous emission light constituting the identification light S12, a band in which the identification light S12 is placed, and a form of the spectral line. In the example illustrated in FIG. 3, the number of the spectral lines is two, the band in which the identification light S12 is placed is a high-frequency side of the main signal band, and the form of the spectral line is rectangular. By locating the identification light S12 also at a low-frequency band side of the main signal band, increasing the number of spectral lines by narrowing a width of the spectral line, and the like, an amount of information in the identification light information can be increased.

Next, an operation on the light monitoring device 100 is described.

When determining that the identification light information indicates the optical device at the previous stage of the optical path switching device 11, the switching state determining unit 130 included in the light monitoring device 100 determines that the optical path switching device 11 is in a switching state of connecting to the optical device.

A case in which the light monitoring device 100 is installed in the terminal station A illustrated in FIG. 2 is descried as an example. In the optical submarine cable system 10, each of the terminal station A and the terminal station B is a trunk station, and the terminal station C is a branch station. In this case, the optical path switching device 11 as the branching unit switches a state in which the terminal station A and the terminal station B are connected (trunk-through), and a state in which the terminal station C and the terminal station A are connected and the terminal station C and the terminal station B are connected (branch-though).

When determining that the identification light information indicates, among the optical devices, a first optical device (the optical device installed in the optical terminal station B) to which the optical path switching device 11 is connected in a first switching state (trunk-through), the switching state determining unit 130 determines that the optical path switching device 11 is in the first switching state (trunk-through). Meanwhile, when determining that the identification light information indicates, among the optical devices, a second optical device (the optical device installed in the terminal station C) to which the optical path switching device 11 is connected in a second switching state (branch-through), the switching state determining unit 130 determines that the optical path switching device 11 is in a second switching state (branch-through).

Next, an operation of the light monitoring device 100 is described in more detail.

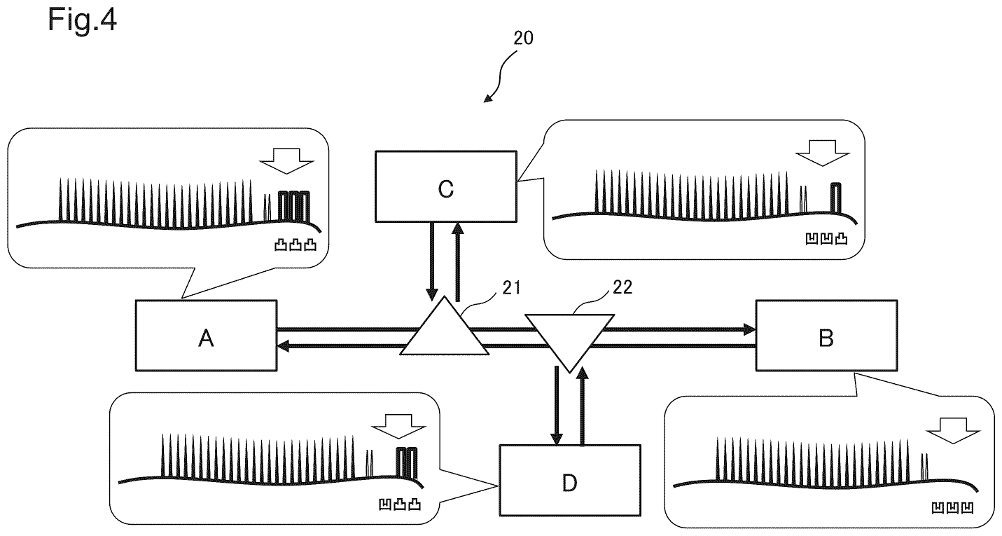

A configuration of an optical submarine cable system 20 including a first optical path switching device 21 and a second optical path switching device 22 as branching units and terminal stations A, B, C, D is illustrated in FIG. 4 as another example of the optical submarine cable system. The light monitoring device 100 and the above-described optical device is installed in each of the terminal stations A, B, C, D. In FIG. 4, a spectrum of propagating light inserted by the optical device installed in each of the terminal stations A, B, C, D is further illustrated. In FIG. 4, an example in which a width of each spectral line of amplified spontaneous emission light (ASE light) constituting the modulating light is similar to that of the main signal light. Alternatively, modulating light constituted of ASE light having a wide (broad) spectral line may be used. Further, a spectrum of supervisory (SV) signal light is further illustrated between the modulating light and the identification light (an area pointed by an arrow) in FIG. 4. The supervisory signal light is used in order to control a submarine apparatus such as a branching unit.

As illustrated in FIG. 4, the optical device installed in each of the terminal stations A, B, C, D inserts identification light having a different spectral form for each of the terminal stations. In the example illustrated in FIG. 4, the optical device installed in the terminal station A inserts identification light constituted of three spectral lines of ASE light. Likewise, identification light constituted of zero spectral line is inserted by the optical device at the terminal station B, identification light constituted of one spectral line is inserted by the optical device at the terminal station C, and identification light constituted of two spectral lines is inserted by the optical device at the terminal station D. Meanwhile, light monitoring devices 100A, 100B, 100C, 100D respectively installed in the terminal stations A, B, C, D receive the identification light. Further, a terminal station that is an insertion source of the identification light is identified based on the number of spectral lines of the ASE light constituting the identification light, and switching states of the first optical path switching device 21 and the second optical path switching device 22 are determined.

Next, by using the example illustrated in FIG. 4, a spectrum of propagating light received by the light monitoring device 100 in each of the terminal stations is described. A terminal station that is an insertion source of the propagating light received by the light monitoring device 100 differs depending on switching states (trunk-through or branch-through) of the first optical path switching device 21 and the second optical path switching device 22. Therefore, by identifying a terminal station that is an insertion source, based on spectral form (in the above-described example, the number of spectral lines of the ASE light) of identification light included in the propagating light, switching states of the first optical path switching device 21 and the second optical path switching device 22 can be determined.

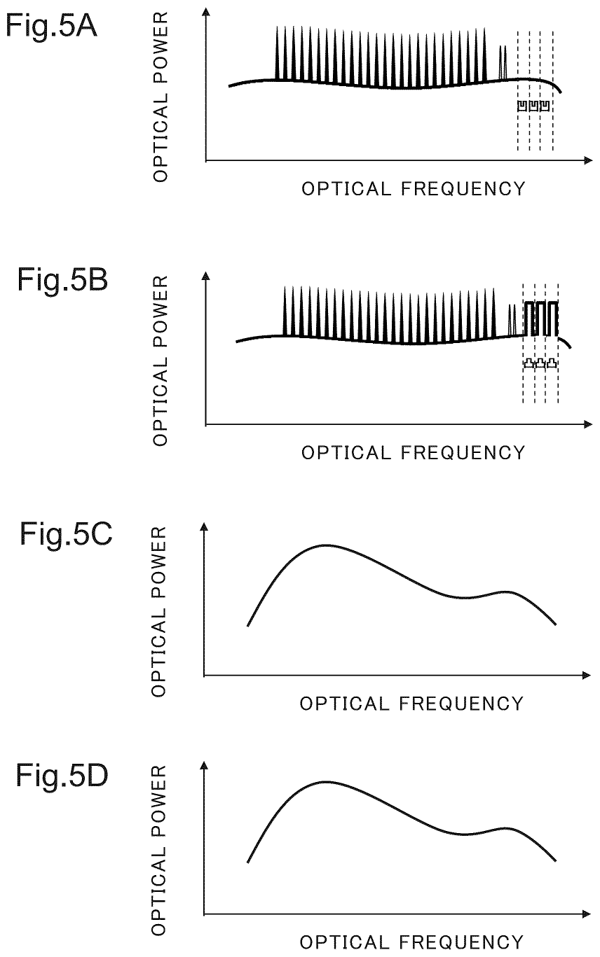

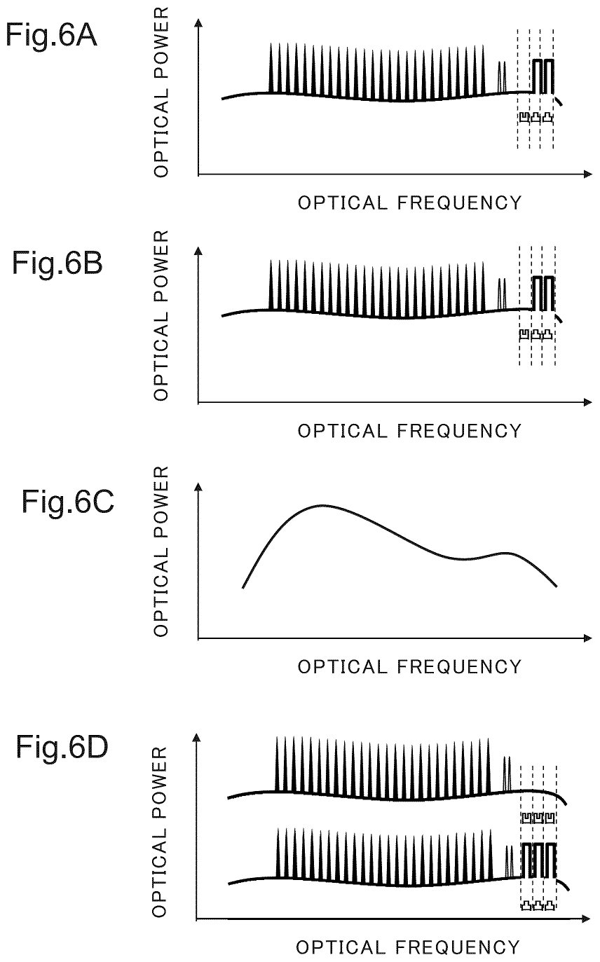

A spectrum of propagating light received by the light monitoring device 100 installed in each of the terminal stations is illustrated in FIGS. 5A to 5D. FIGS. 5A to 5D illustrates a case in a first switching pattern in which both the first optical path switching device 21 and the second optical path switching device 22 are in the first switching state (trunk-through). FIG. 5A illustrates a propagating light spectrum received by the light monitoring device 100A installed in the terminal station A, FIG. 5B illustrates a propagating light spectrum received by the light monitoring device 100D installed in the terminal station B, FIG. 5C illustrates a propagating light spectrum received by the light monitoring device 100D installed in the terminal station C, and FIG. 5D illustrates a propagating light spectrum received by the light monitoring device 100D installed in the terminal station D. The same also applies to the following FIGS. 6A to 6D, FIGS. 7A to 7D, and FIGS. 8A to 8D.

As illustrated in FIG. 5B, the light monitoring device 100B installed in the terminal station B receives identification light constituted of three spectral lines. Thereby, the light monitoring device 100B identifies that an insertion source of the identification light is the optical device installed in the terminal station A, and that switching states of the first optical path switching device 21 and the second optical path switching device 22 are the first switching pattern. Meanwhile, As illustrated in FIG. 5C, the light monitoring device 100C installed in the terminal station C does not receive propagating light and receives only amplified spontaneous emission light (ASE light) noise that is added by an optical repeater. In this case, the light monitoring device 100C determines that a switching state of the first optical path switching device 21 is the first switching state (trunk-through).

A spectrum of propagating light received by the light monitoring device 100 in a second switching pattern in which the first optical path switching device 21 is in the first switching state (trunk-through) and the second optical path switching device 22 is in the second switching state (branch-through) is illustrated in FIGS. 6A to 6D. As illustrated in FIGS. 6A and 6B, each of the light monitoring device 100A and the light monitoring device 100B receives identification light constituted of two spectral lines. Therefore, each of the light monitoring device 100A and the light monitoring device 100B identifies that an insertion source of the identification light is the optical device installed in the terminal station D. Thereby, the light monitoring device 100A determine that switching states of the first optical path switching device 21 and the second optical path switching device 22 are the second switching pattern. Meanwhile, the light monitoring device 100B determines that a switching state of the second optical path switching device 22 is the second switching state (branch-through).

Further, as illustrated in FIG. 6D, the light monitoring device 100D receives identification light constituted of three spectral lines. Therefore, the light monitoring device 100D identifies that an insertion source of the identification light is the optical device installed in the terminal station A. Therefore, the light monitoring device 100D determined that switching states of the first optical path switching device 21 and the second optical path switching device 22 are the second switching pattern.

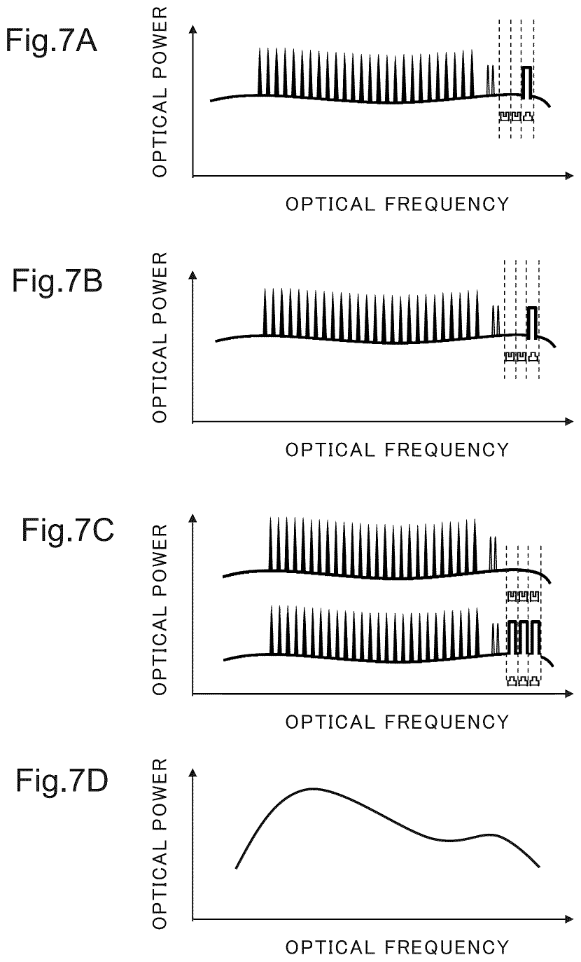

A spectrum of propagating light received by the light monitoring device 100 in a third switching pattern in which the first optical path switching device 21 is in the second switching state (branch-through) and the second optical path switching device 22 is in the first switching state (trunk-through) is illustrated in FIGS. 7A to 7D. As illustrated in FIGS. 7A and 7B, each of the light monitoring device 100A and the light monitoring device 100B receives identification light constituted of one spectral line. Therefore, each of the light monitoring device 100A and light monitoring device 100B identified that an insertion source of the identification light is the optical device installed in the terminal station C. Thereby, the light monitoring device 100A determines that the first optical path switching device 21 is in the second switching state (branch-through). Meanwhile, the light monitoring device 100B determines that switching states of the first optical path switching device 21 and the second optical path switching device 22 is the third switching pattern.

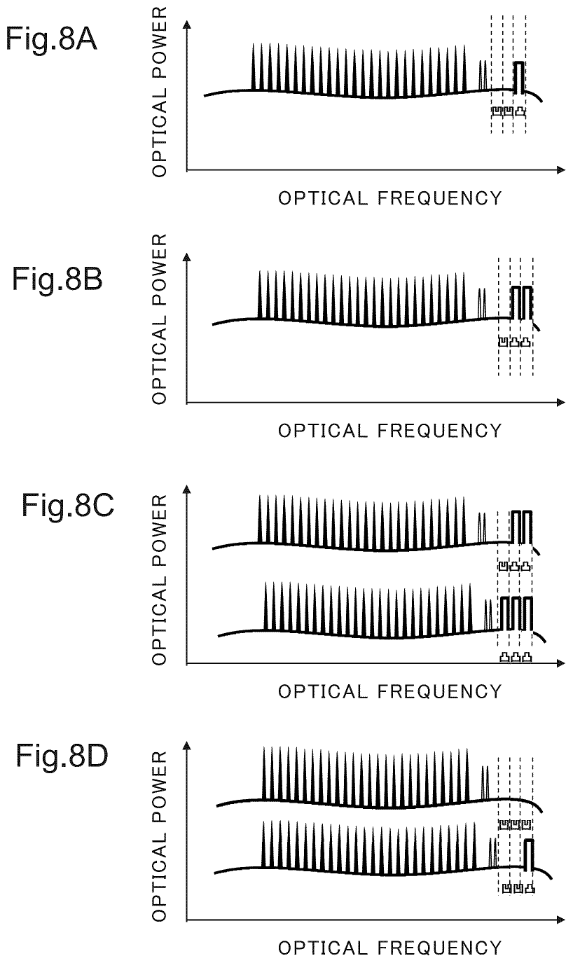

A spectrum of the propagating light received by the light monitoring device 100 in a fourth switching pattern in which both the first optical path switching device 21 and the second optical path switching device 22 are in the second switching state (branch-though) is illustrated in FIGS. 8A to 8D. As illustrated in FIGS. 8A and 8D, each of the light monitoring device 100A and the light monitoring device 100D receives identification light constituted of one spectral line. Therefore, each of the light monitoring device 100A and the light monitoring device 100D identifies that an insertion source is the optical device installed in the terminal station C. Thereby, the light monitoring device 100A determines that the first optical path switching device 21 is in the second switching state (branch-through). Meanwhile, the light monitoring device 100D determines that switching states of the first optical path switching device 21 and the second optical path switching device 22 are the fourth switching pattern.

Note that, by combining identification light information (in the above-described example, the number of spectral lines of ASE light constituting the identification light) acquired by each of the light monitoring devices 100A to 100D, a switching state of each of the optical path switching devices can be determined. Specifically, for example, the light monitoring device 100A (a first light monitoring device) generates first identification light information being the identification light information, the light monitoring device 100B (a second light monitoring device) generates second identification light information being the identification light information. In this case, the light monitoring device 100A (the first light monitoring device) and the light monitoring device 100B (the second light monitoring device) can be configured in such a way as to determine the switching state, based on at least one of the first identification light information and the second identification light information.

In a case in which the number of the terminal stations increases and the number of the light monitoring device 100 increases, a switching state of the optical path switching device can be determined in a similar way as in the above-described example, by increasing an amount of information in the identification light information. Specifically, the amount of information in the identification light information identification light can be increased by placing identification light on both the high-frequency band side and the low-frequency band side of the main signal band, increasing the number of spectral lines by narrowing a width of the spectral line, and the like.

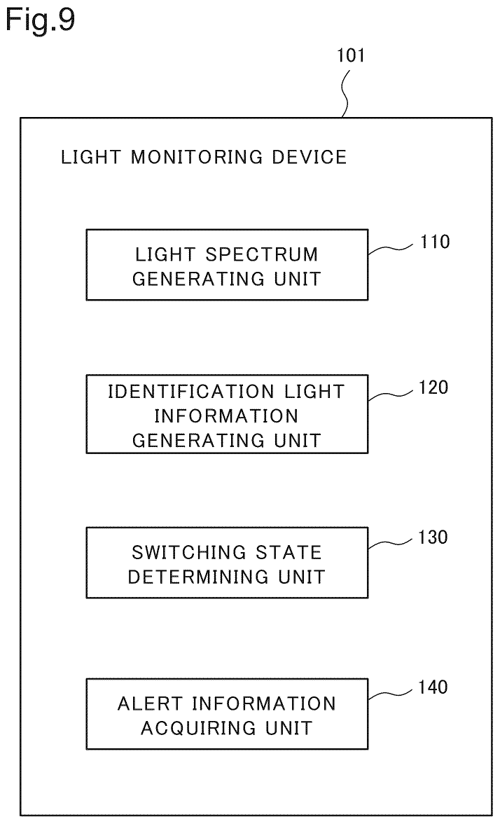

The light monitoring device according to the present example embodiment may be configured in such a way as to further include an alert information acquiring unit (an alert information acquisition means) 140, as in a light monitoring device 101 illustrated in FIG. 9. The alert information acquiring unit 140 acquires alert information from identification light information. Herein, the alert information acquiring unit 140 may be configured in such a way as to acquire the alert information from a form of a spectral line of amplified spontaneous emission light constituting the identification light.

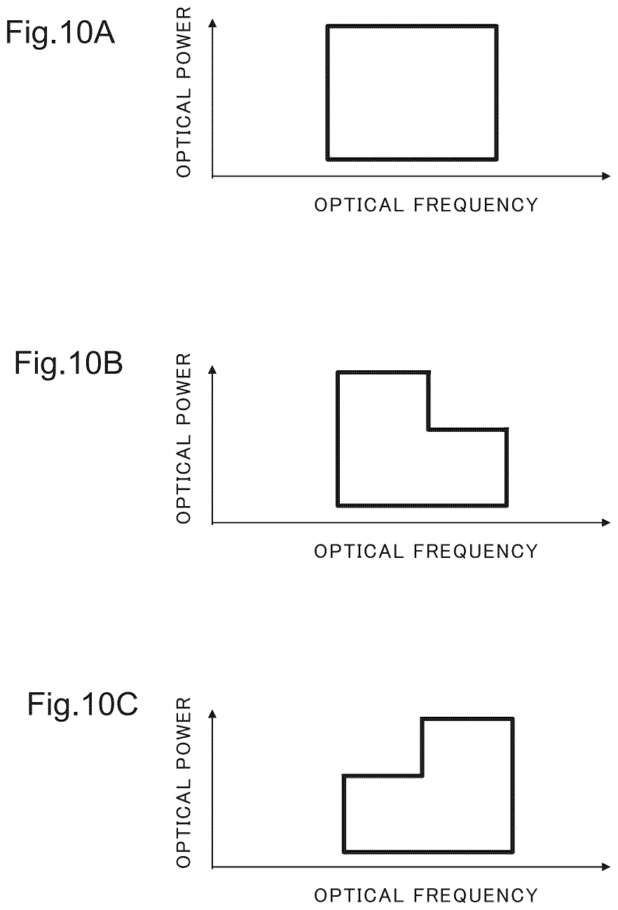

The form of the spectral line of the amplified spontaneous emission light (ASE light) is schematically illustrated in FIGS. 10A to 10C. Specifically, for example, as illustrated in FIG. 10A, when the form of the spectral line of the ASE light is rectangular, an optical device that has inserted the identification light may be determined to be operating normally. Further, as illustrated in FIGS. 10B and 10C, when the form of the spectral line is a stepped form, in the example illustrated in FIG. 10B, the optical device can be determined to be in a state in which a first alert has been issued, and in the example illustrated in FIG. 10C, the optical device can be determined to be in a state in which a second alert has been issued.

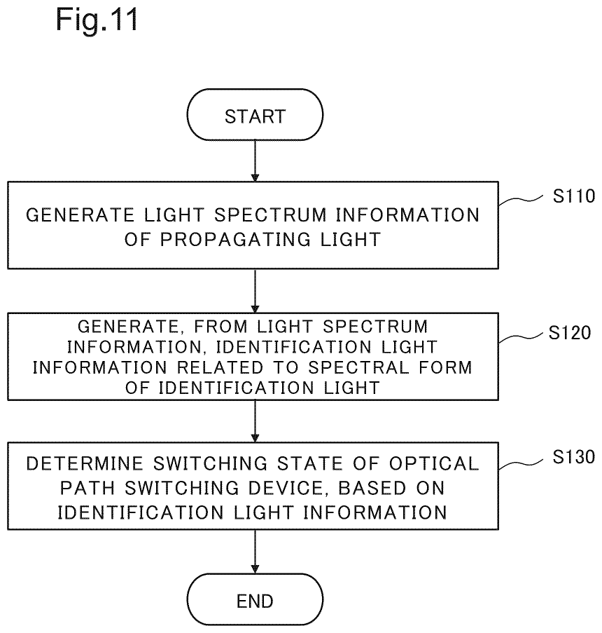

Next, a light monitoring method according to the present example embodiment is described with reference to a flowchart illustrated in FIG. 11.

In the light monitoring method according to the present example embodiment, first, light spectrum information of propagating light propagating via an optical path switching device that switches a signal light path is generated (step S110). Identification light information related to a spectral form of identification light included in the propagating light is generated from the light spectrum information (step S120). Then, a switching state of the optical path switching device is determined based on the identification light information (step S130).

Thus, the light monitoring method according to the present example embodiment is configured in such a way that a switching state of an optical path switching device is determined based on identification light information relevant to a spectral form of identification light included in propagating light. Therefore, there is no need to introduce an optical transceiver such as a transponder in order to determine a switching state of the optical path switching device. Specifically, according to the light monitoring method of the present example embodiment, a switching state of a branching unit during initial introduction can be monitored, even in an optical submarine cable system based on an open cable method.

Herein, the above-described determination of the switching state may be configured in such a way as to include, when it is determined that the identification light information indicates an optical device at a previous stage of the optical path switching device, determining that the optical path switching device is in a switching state of connecting to the optical device. Further, the above-described determination of the switching state may include, when it is determined that the identification light information indicates, among the optical devices, the first optical device to which the optical path switching device is connected in the first switching state, determining that the optical path switching device is in the first switching state. Further, the above-described determination of the switching state may be configured in such a way as to include, when it is determined that the identification light information indicates, among the optical devices, the second optical device to which the optical path switching device is connected in the second switching state, determining that the optical path switching device is in the second switching state.

The above-described propagating light is amplified spontaneous emission light that is inserted at the optical device at the previous stage of the optical path switching device. Further, the above-described identification light is amplified spontaneous emission light having a different spectral form for each optical device. Further, the above-described propagating light can be configured in such a way as to include, in a main signal band, modulating light for keeping output optical intensity of the optical device constant, and include the identification light in a non-allocated band excluding the main signal band. Further, the above-described spectral form can be at least one of the number of spectral lines of the amplified spontaneous emission light constituting the identification light, a band in which the identification light is placed, and a form of the spectral line.

The light monitoring method according to the present example embodiment can be configured in such a way as to further include acquiring the alert information from the above-described identification light information. Herein, the acquisition of the alert information can include acquiring alert information from a form of the spectral line of the amplified spontaneous emission light constituting the identification light.

As described above, according to the light monitoring devices 100, 101, and the light monitoring method of the present example embodiment, a switching state of the branching unit during initial introduction can be monitored, even in an optical submarine cable system based on an open cable method.

### Second Example Embodiment

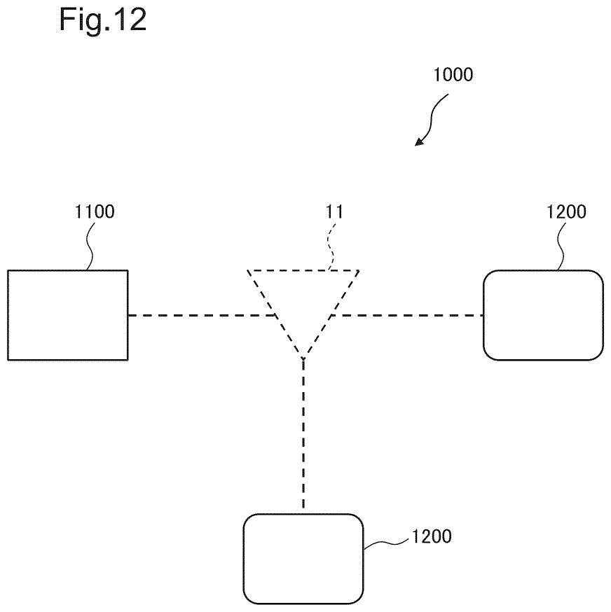

Next, a second example embodiment according to the present invention is described. A configuration of a light monitoring system 1000 according to the present example embodiment is illustrated in FIG. 12. The light monitoring system 1000 includes a light monitoring device 1100 and an optical device 1200. Preferably, the light monitoring system 1000 is used in an optical submarine cable system. In this case, a configuration in which the light monitoring device 1100 is installed, for example, in a terminal station A of an optical submarine cable system 10 illustrated in FIG. 2 and the optical device 1200 is installed in a terminal station B or a terminal station C can be employed.

The light monitoring device 1100 can be the light monitoring device 100 according to the first example embodiment. Specifically, the light monitoring device 1100 includes a light spectrum generating unit 110, an identification light information generating unit 120, and a switching state determining unit 130 (see FIG. 1).

As described in the first example embodiment, the light monitoring device 100 is configured in such a way as to determine a switching state of an optical path switching device 11, based on identification light information related to a spectral form of identification light included in propagating light. Therefore, there is no need to introduce an optical transceiver such as a transponder in order to determining a switching state of the optical path switching device 11. Specifically, according to the light monitoring device 100 of the present example embodiment, a switching state of a branching unit during initial introduction can be monitored, even in an optical submarine cable system based on an open cable method.

The optical device 1200 is at a previous stage of the optical path switching device. The optical device 1200 emits propagating light constituted of amplified spontaneous emission light. The propagating light includes, in a main signal band, modulating light for keeping output optical intensity of the optical device 1200 constant, and includes identification light in a non-allocated band excluding the main signal band. Herein, the identification light is amplified spontaneous emission light having a different spectral form for each optical device 1200.

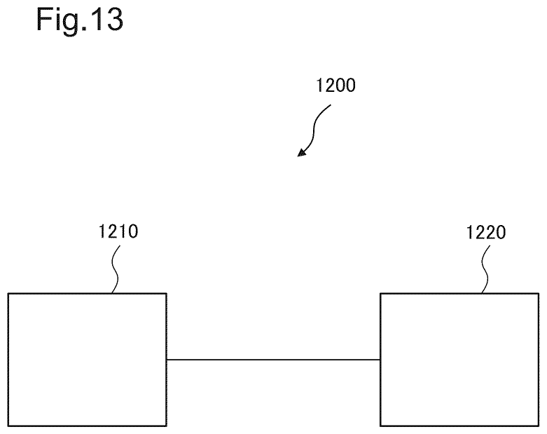

A configuration of the optical device 1200 is illustrated in FIG. 13. The optical device 1200 includes a light generating unit (a light generating means) 1210 and a light controlling unit (a light controlling means) 1220. The light generating unit 1210 generates amplified spontaneous emission light. Further, the light controlling unit 1220 controls a band and power of the amplified spontaneous emission light and thereby generates propagating light.

Herein, the light generating unit 1210 can be configured in such a way as to include a pump laser that generates pumping light for exciting an optical waveguide including a rare-earth element in its core and the rare-earth element. Specifically, for example, an amplified spontaneous emission (ASE) light source including an amplifier that is in a state in which no signal is input and uses an erbium-doped fiber (erbium doped fiber amplifier: EDFA) as an optical waveguide can be used as the light generating unit 1210.

The light controlling unit 1220 can be configured in such a way as to include a wavelength selective switch (WSS). The wavelength selective switch (WSS) can adjust a power attenuation amount of input light for each wavelength. By employing the wavelength selective switch (WSS) in a one-input and one-output configuration, output light having a waveform of the input light formed into any form.

As the optical device 1200, a dummy light generating block included in an optical interface device (open cable interface: OCI) used in a terminal station device of an optical submarine cable system based on an open cable method can be used. Alternatively, apart from the optical interface device (OCI), an ASE light source may be used as the optical device 1200.

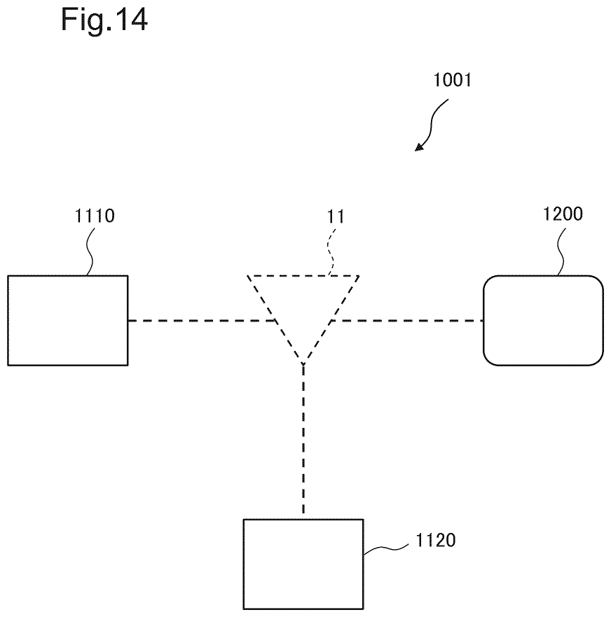

The light monitoring system according to the present example embodiment can be configured in such a way as to include a first light monitoring device 1110 and a second light monitoring device 1120, as in a light monitoring system 1001 illustrated in FIG. 14. Herein, a configuration in which the first light monitoring device 1110 is installed, for example, in a terminal station A of an optical submarine cable system 20 illustrated in FIG. 4, and the second light monitoring device 1120 is installed in a terminal station C or a terminal station D can be employed.

The first light monitoring device 1110 generates first identification light information being the identification light information. The second light monitoring device 1120 generates second identification light information being the identification light information. Further, the first light monitoring device 1110 and the second light monitoring device 1120 determine a switching state of the optical path switching device 11, based on at least one of the first identification light information and the second identification light information.

By employing such a configuration, a switching state of each of the optical path switching devices can be determined even when the number of the optical path switching devices increases.

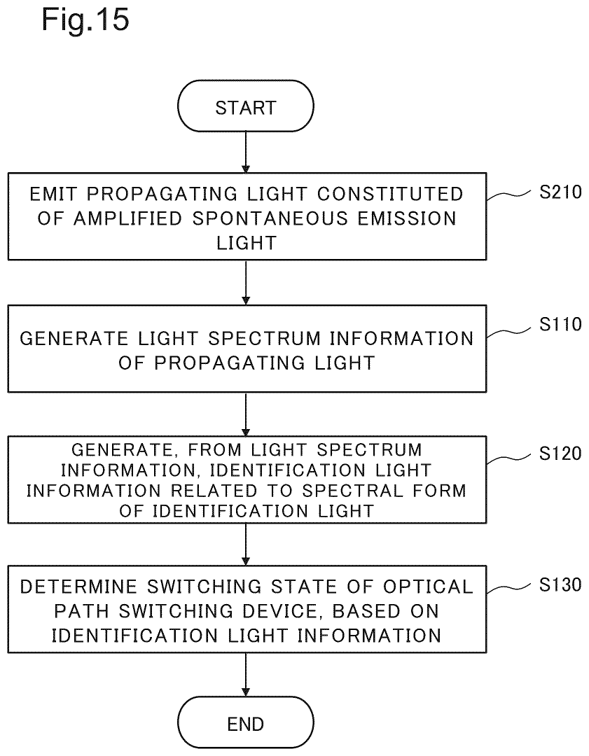

Next, a light monitoring method according to the present example embodiment is described with reference to a flowchart illustrated in FIG. 15.

In the light monitoring method according to the present example embodiment, first, propagating light constituted of amplified spontaneous emission light is emitted (step S210). Next, as in the light monitoring method according to the first example embodiment, light spectrum information of the propagating light propagating via an optical path switching device that switches a signal light path is generated (step S110). Identification light information related to a spectral form of identification light included in the propagating light is generated from the light spectrum information (step S120). Then, a switching state of the optical path switching device is determined based on the identification light information (step S130).

The above-described emission of propagating light may be configured in such a way as to include generating amplified spontaneous emission light and generating propagating light by controlling a band and power of the amplified spontaneous emission light.

Herein, the above-described identification light is amplified spontaneous emission light having a different spectral form for each optical device at a previous stage of the optical path switching device. Further, the above-described propagating light can be configured in such a way as to include, in a main signal band, modulating light for keeping output optical intensity of the optical device constant, and include the identification light in a non-allocated band excluding the main signal band.

The light monitoring method according to the present example embodiment can also be configured in such a way as to include generating the first identification light information being the identification light information, generating the second identification light information being the identification light information, and determining a switching state, based on at least one of the first identification light information and the second identification light information.

As described above, according to the light monitoring systems 1000, 1001, and the light monitoring method of the present example embodiment, a switching state of a branching unit during initial introduction can be monitored, even in an optical submarine cable system based on an open cable method.

A part or the entirety of the above-described example embodiments may be described as the following Supplementary Notes, but is not limited thereto.

(Supplementary Note 1) A light monitoring device including: a light spectrum generating means for generating light spectrum information of propagating light propagating via an optical path switching device that switches a signal light path; an identification light information generating means for generating, from the light spectrum information, identification light information related to a spectral form of identification light included in the propagating light; and a switching state determining means for determining a switching state of the optical path switching device, based on the identification light information.

(Supplementary Note 2) The light monitoring device according to Supplementary Note 1, in which, when determining that the identification light information indicates an optical device at a previous stage of the optical path switching device, the switching state determining means determines that the optical path switching device is in a switching state of connecting to the optical device.

(Supplementary Note 3) The light monitoring device according to Supplementary Note 2, in which, when determining that the identification light information indicates, among the optical devices, a first optical device to which the optical path switching device is connected in a first switching state, the switching state determining means determines that the optical path switching device is in the first switching state, and when determining that the identification light information indicates, among the optical devices, a second optical device to which the optical path switching device is connected in a second switching state, the switching state determining means determines that the optical path switching device is in the second switching state.

(Supplementary Note 4) The light monitoring device according to Supplementary Note 1, in which the propagating light is amplified spontaneous emission light inserted in an optical device at a previous stage of the optical path switching device, and the identification light is the amplified spontaneous emission light having the spectral form different for each of the optical devices.

(Supplementary Note 5) The light monitoring device according to Supplementary Note 4, in which the propagating light includes, in a main signal band, modulating light for keeping output optical intensity of the optical device constant, and includes the identification light in a non-allocated band excluding the main signal band.

(Supplementary Note 6) The light monitoring device according to Supplementary Note 4 or 5, in which the spectral form is at least one of a number of spectral lines of the amplified spontaneous emission light constituting the identification light, a band in which the identification light is placed, and a form of the spectral line.

(Supplementary Note 7) The light monitoring device according to Supplementary Note 1, further including an alert information acquisition means for acquiring alert information from the identification light information.

(Supplementary Note 8) The light monitoring device according to Supplementary Note 7, in which the alert information acquisition means acquires the alert information from a form of a spectral line of amplified spontaneous emission light constituting the identification light.

(Supplementary Note 9) A light monitoring system including: a first light monitoring device being the light monitoring device according to any one of Supplementary Notes 1 to 8; and a second light monitoring device being the light monitoring device according to any one of Supplementary Notes 1 to 8, in which the first light monitoring device generates first identification light information being the identification light information, the second light monitoring device generates second identification light information being the identification light information, and the first light monitoring device and the second light monitoring device determines the switching state, based on at least one of the first identification light information and the second identification light information.

(Supplementary Note 10) A light monitoring system including: the light monitoring device according to Supplementary Note 1; and an optical device at a previous stage of the optical path switching device, in which
the optical device emits the propagating light constituted of amplified spontaneous emission light, and
the identification light is the amplified spontaneous emission light having the spectral form different for each of the optical devices.

(Supplementary Note 11) The light monitoring system according to Supplementary Note 10, in which the propagating light includes, in a main signal band, modulating light for keeping output optical intensity of the optical device constant, and includes the identification light in a non-allocated band excluding the main signal band.

(Supplementary Note 12) The light monitoring system according to Supplementary Note 10 or 11, in which the optical device includes a light generating means for generating the amplified spontaneous emission light, and a light controlling means for generating the propagating light by controlling a band and power of the amplified spontaneous emission light.

(Supplementary Note 13) A light monitoring method including: generating light spectrum information of propagating light propagating via an optical path switching device that switches a signal light path; generating, from the light spectrum information, identification light information related to a spectral form of identification light included in the propagating light; and determining a switching state of the optical path switching device, based on the identification light information.

(Supplementary Note 14) The light monitoring method according to Supplementary Note 13, in which the determining the switching state includes, when determining that the identification light information indicates an optical device at a previous stage of the optical path switching device, determining that the optical path switching device is in a switching state of connecting to the optical device.

(Supplementary Note 15) The light monitoring method according to Supplementary Note 14, in which the determining the switching state includes, when determining that the identification light information indicates, among the optical devices, a first optical device to which the optical path switching device is connected in a first switching state, determining that the optical path switching device is in the first switching state, and, when determining that the identification light information indicates, among the optical devices, a second optical device to which the optical path switching device is connected in a second switching state, determining that the optical path switching device is in the second switching state.

(Supplementary Note 16) The light monitoring method according to Supplementary Note 13, in which the propagating light is amplified spontaneous emission light inserted in an optical device at a previous stage of the optical path switching device, and the identification light is the amplified spontaneous emission light having the spectral form different for each of the optical devices.

(Supplementary Note 17) The light monitoring method according to Supplementary Note 16, in which the propagating light includes, in a main signal band, modulating light for keeping output optical intensity of the optical device constant, and includes the identification light in a non-allocated band excluding the main signal band.

(Supplementary Note 18) The light monitoring method according to Supplementary Note 16 or 17, in which the spectral form is at least one of the number of spectral lines of the amplified spontaneous emission light constituting the identification light, a band at which the identification light is placed, and a form of the spectral line.

(Supplementary Note 19) The light monitoring method according to Supplementary Note 13, further including acquiring alert information from the identification light information.

(Supplementary Note 20) The light monitoring method according to Supplementary Note 19, in which the acquiring the alert information includes acquiring the alert information from a form of a spectral line of amplified spontaneous emission light constituting the identification light.

(Supplementary Note 21) The light monitoring method according to any one of Supplementary Notes 13 to 20, further including: generating first identification light information being the identification light information; generating second identification light information being the identification light information; and determining the switching state, based on at least one of the first identification light information and the second identification light information.

(Supplementary Note 22) The light monitoring method according to Supplementary Note 13, further including emitting the propagating light constituted of amplified spontaneous emission light, in which the identification light is the amplified spontaneous emission light having the spectral form different for each optical device at a previous stage of the optical path switching device.

(Supplementary Note 23) The light monitoring method according to Supplementary Note 22, in which the propagating light includes, in a main signal band, modulating light for keeping output optical intensity of the optical device constant, and includes the identification light in a non-allocated band excluding the main signal band.

(Supplementary Note 24) The light monitoring method according to Supplementary Note 22 or 23, in which the emitting the propagating light includes generating the amplified spontaneous emission light and generating the propagating light by controlling a band and power of the amplified spontaneous emission light.

While the invention has been particularly shown and described with reference to exemplary embodiments thereof, the invention is not limited to these embodiments. It will be understood by those of ordinary skill in the art that various changes in form and details may be made therein without departing from the spirit and scope of the present invention as defined by the claims.

### REFERENCE SIGNS LIST

100, 101, 1100 Light monitoring device
110 Light spectrum generating unit
120 Identification light information generating unit
130 Switching state determining unit
140 Alert information acquiring unit
1000, 1001 Light monitoring system
1110 First light monitoring device
1120 Second light monitoring device
1200 Optical device
1210 Light generating unit
1220 Light controlling unit
10, 20 Optical submarine cable system
11 Optical path switching device
12 Optical repeater
21 First optical path switching device
22 Second optical path switching device

What is claimed is:

1. A light monitoring device comprising:
a light spectrum generator configured to generate light spectrum information of propagating light propagating via an optical path switching device that switches a signal light path;
an identification light information generator configured to generate, from the light spectrum information, identification light information related to a spectral form of identification light included in the propagating light; and
a switching state determiner configured to determine a switching state of the optical path switching device, based on the identification light information.

2. The light monitoring device according to claim 1, wherein,
when determining that the identification light information indicates an optical device at a previous stage of the optical path switching device, the switching state determiner determines that the optical path switching device is in a switching state of connecting to the optical device.

3. The light monitoring device according to claim 2, wherein,
when determining that the identification light information indicates, among the optical devices, a first optical device to which the optical path switching device is connected in a first switching state, the switching state determiner determines that the optical path switching device is in the first switching state, and
when determining that the identification light information indicates, among the optical devices, a second optical device to which the optical path switching device is connected in a second switching state, the switching state determiner determines that the optical path switching device is in the second switching state.

4. The light monitoring device according to claim 1, wherein
the propagating light is amplified spontaneous emission light inserted in an optical device at a previous stage of the optical path switching device, and
the identification light is the amplified spontaneous emission light having the spectral form different for each of the optical devices.

5. The light monitoring device according to claim 4, wherein
the propagating light
includes, in a main signal band, modulating light for keeping output optical intensity of the optical device constant, and includes the identification light in a non-allocated band excluding the main signal band.

6. The light monitoring device according to claim 4, wherein
the spectral form is at least one of a number of spectral lines of the amplified spontaneous emission light constituting the identification light, a band in which the identification light is placed, and a form of the spectral line.

7. The light monitoring device according to claim 1, further comprising
an alert information acquisition circuit configured to acquire alert information from the identification light information.

8. The light monitoring device according to claim 7, wherein
the alert information acquisition circuit acquires the alert information from a form of a spectral line of amplified spontaneous emission light constituting the identification light.

9-12. (canceled)

13. A light monitoring method comprising:
generating light spectrum information of propagating light propagating via an optical path switching device that switches a signal light path;
generating, from the light spectrum information, identification light information related to a spectral form of identification light included in the propagating light; and
determining a switching state of the optical path switching device, based on the identification light information.

14. The light monitoring method according to claim 13, wherein
the determining the switching state includes,
when determining that the identification light information indicates an optical device at a previous stage of the optical path switching device, determining that the optical path switching device is in a switching state of connecting to the optical device.

15. The light monitoring method according to claim 14, wherein
the determining the switching state includes,
when determining that the identification light information indicates, among the optical devices, a first optical device to which the optical path switching device is connected in a first switching state, determining that the optical path switching device is in the first switching state, and,
when determining that the identification light information indicates, among the optical devices, a second optical device to which the optical path switching device is connected in a second switching state, determining that the optical path switching device is in the second switching state.

16. The light monitoring method according to claim 13, wherein
the propagating light is amplified spontaneous emission light inserted in an optical device at a previous stage of the optical path switching device, and
the identification light is the amplified spontaneous emission light having the spectral form different for each of the optical devices.

17. The light monitoring method according to claim 16, wherein
the propagating light
includes, in a main signal band, modulating light for keeping output optical intensity of the optical device constant, and includes the identification light in a non-allocated band excluding the main signal band.

18. The light monitoring method according to claim 16, wherein
the spectral form is at least one of a number of spectral lines of the amplified spontaneous emission light constituting the identification light, a band at which the identification light is placed, and a form of the spectral line.

19. The light monitoring method according to claim 13, further comprising acquiring alert information from the identification light information.

20. The light monitoring method according to claim 19, wherein
the acquiring the alert information includes acquiring the alert information from a form of a spectral line of amplified spontaneous emission light constituting the identification light.

21. The light monitoring method according to claim 13, further comprising:
generating first identification light information being the identification light information;
generating second identification light information being the identification light information; and
determining the switching state, based on at least one of the first identification light information and the second identification light information.

22. The light monitoring method according to claim 13, further comprising
emitting the propagating light constituted of amplified spontaneous emission light, wherein
the identification light is the amplified spontaneous emission light having the spectral form different for each optical device at a previous stage of the optical path switching device.

23. The light monitoring method according to claim 22, wherein
the propagating light includes, in a main signal band, modulating light for keeping output optical intensity of the optical device constant, and includes the identification light in a non-allocated band excluding the main signal band.

24. The light monitoring method according to claim 22, wherein
the emitting the propagating light includes
generating the amplified spontaneous emission light, and
generating the propagating light by controlling a band and power of the amplified spontaneous emission light.
